(19) United States
(12) Patent Application Publication
(10) Pub. No.: US 2013/0143627 A1
(43) Pub. Date: Jun. 6, 2013

(54) ELECTRONIC DEVICE

(71) Applicant: SAMSUNG ELECTRONICS CO., LTD., Suwon-si (KR)

(72) Inventors: Shi-Chang RHO, Yongin-si (KR); Hun-Kee KIM, Seoul (KR); Kwang-Chul KIM, Seongnam-si (KR); Jeong-Yeon SEO, Seoul (KR)

(73) Assignee: SAMSUNG ELECTRONICS CO. LTD., Suwon-si, (KR)

(21) Appl. No.: 13/693,336

(22) Filed: Dec. 4, 2012

(30) Foreign Application Priority Data
Dec. 5, 2011 (KR) 10-2011-0128979

(51) Int. Cl. H04M 1/247

(52) U.S. Cl. CPC H04M 1/2471
USPC 455/566

(57) ABSTRACT

An electronic device is provided. The electronic device includes an output unit, a storage unit, an antenna, a sensor, and a controller. The output unit outputs a video or voice. The storage unit stores information about a user interface operation. The antenna transmits/receives a wireless signal of a corresponding communication frequency band and is moveable. The sensor acquires information of at least one motion of the antenna. The controller processes a wireless signal through the antenna and outputs the user interface operation according to the information received from the sensor, to the output unit with reference to the information of the storage unit.

### PRIORITY

This application claims the benefit under 35 U.S.C. §119(a) of a Korean patent application filed on Dec. 5, 2011, in the Korean Intellectual Property Office and assigned Serial No. 10-2011-0128979, the entire disclosure of which is hereby incorporated by reference.

### BACKGROUND OF THE INVENTION

1. Field of the Invention

The present invention relates to an electronic device for providing a user interface operation using an antenna.

2. Description of the Related Art

At present, owing to the development of the electronic communication industry, electronic devices such as mobile communication terminals (i.e., cellular phones), electronic schedulers, personal complex terminals, and the like, are becoming necessities to modern society while becoming a significant means of delivery of rapidly changing information.

In recent years, the electronic devices have added functions incrementally, while they have been miniaturized in size and, because of this, part mounting is gradually getting difficult. Further, as a Graphical User Interface (GUI) has been widely used, many electronic devices have come to prefer a larger screen and provide a high-quality 3-Dimensional (3D) graphic video. If a screen gets big, undoubtedly, an overall size of the equipment becomes large as well. Therefore, as a method for miniaturizing equipment but concurrently constructing a larger screen, an alternative of reducing the number of hardware buttons or applying a touch screen has been widely presented. However, because the electronic device provides only a manipulation means using a general hardware button for control of a 3D graphic based operation or a touch screen although providing the 3D graphic based operation, a user cannot be given a feeling of satisfaction. For instance, in a 3D graphic game, the user can spatially move an object even with a general direction key button, but is given a feeling of monotonous manipulation. As a result, there is a need for a user interface environment capable of miniaturizing the electronic device while giving satisfaction to the user.

Therefore, a need exists for a system and method for a user interface apparatus and method using an antenna of an electronic device.

The above information is presented as background information only to assist with an understanding of the present disclosure. No determination has been made, and no assertion is made, as to whether any of the above might be applicable as prior art with regard to the present invention.

### SUMMARY OF THE INVENTION

An aspect of the present invention is to address at least the above-mentioned problems and/or disadvantages and to provide at least the advantages below. Accordingly, an aspect of the present invention is to provide a user interface apparatus and method using an antenna of an electronic device.

Another aspect of the present invention is to provide a user interface environment capable of miniaturizing an electronic device while giving satisfaction to a user.

A further aspect of the present invention is to provide a user interface apparatus and method capable of satisfying a feeling of a user's manipulation in a Graphical User Interface (GUI) environment based on 3-Dimensional (3D) graphics.

The above aspects are achieved by providing an electronic device.

According to an aspect of the present invention, an electronic device is provided. The electronic device includes an output unit, a storage unit, an antenna, a sensor, and a controller. The output unit outputs a video or voice. The storage unit stores information about a user interface operation. The antenna transmits/receives a wireless signal of a corresponding communication frequency band and is moveable. The sensor acquires information of at least one motion of the antenna. The controller processes a wireless signal through the antenna, and outputs the user interface operation according to the information received from the sensor, to the output unit with reference to the information of the storage unit.

According to another aspect of the present invention, a user interface method is provided. The method includes acquiring information of at least one motion of an antenna, and performing a user interface operation according to the information of the at least one motion of the antenna.

According to a further aspect of the present invention, an electronic device is provided. The electronic device includes means for outputting a video or voice, means for storing information about a user interface operation, a moveable antenna for transmitting/receiving a wireless signal of a corresponding communication frequency band, means for acquiring information of at least one motion of the antenna, and means for processing a wireless signal through the antenna and outputting the user interface operation according to the information of the at least one motion of the antenna with reference to the information of the storage means.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view illustrating an electronic device according to an exemplary embodiment of the present invention;

FIG. 2 is a diagram depicting a construction of an antenna according to an exemplary embodiment of the present invention;

FIG. 3 is a block diagram illustrating a construction of an electronic device according to an exemplary embodiment of the present invention;

FIG. 4 is a flowchart illustrating a procedure of performing a user interface operation according to an exemplary embodiment of the present invention;

FIGS. 5 to 8 are diagrams depicting antennas according to exemplary embodiments of the present invention; and

FIGS. 9 to 12 are diagrams depicting user interface screens according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention relates to a user interface apparatus and method using an antenna of an electronic device. The user interface apparatus and method of the present invention can miniaturize the electronic device while satisfying a feeling of user's manipulation in a Graphical User Interface (GUI) environment based on 3-Dimensional (3D) graphic, although the present invention is not limited thereto. For example, aspects of the present invention may also be embodied with 2-Dimensional (2D) graphics, or with various functions and features that are independent of graphics such as an audio volume level.

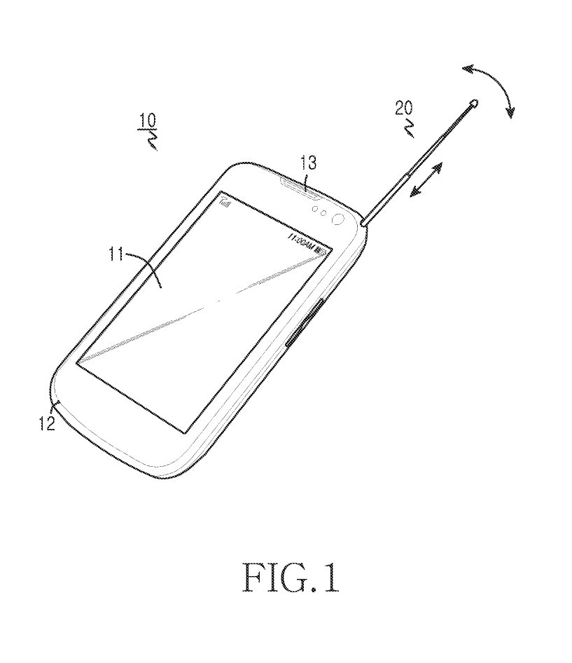

FIG. 1 is a perspective view illustrating an electronic device according to an exemplary embodiment of the present invention.

Referring to FIG. 1, the electronic device 10 includes a display 11, a microphone 12, and a speaker 13, which are known in the related art. The electronic device 10 also includes a touch screen, and the input function of this touch screen can be replaced or supplemented with one or more general key buttons.

The electronic device 10 includes an antenna 20 capable of providing a communication service and transmitting/receiving a signal of at least one or more communication frequency bands. This antenna 20 can be used for calls and Digital Multimedia Broadcasting (DMB). Particularly, the antenna 20 can be moved. For example, the antenna 20 can be inserted inside the electronic device 10 or can protrude outside the electronic device 10. Also, the antenna 20 can rotate one end on a pivot of the other end. Also, the antenna 20, which can be retracted in an outside protrusion state, can be of a construction in which metal tubes of different diameters overlap one another in order. The antenna 20 may be rigid, telescoping, partially flexible, or fully flexible according to exemplary embodiments of the present invention. Particularly, the electronic device 10 permits the antenna 20 as a manipulation means. The electronic device 10 outputs a user interface operation resulting from a motion of the antenna 20, to the display 11 or the speaker 13. This user interface operation is described later with reference to the drawings.

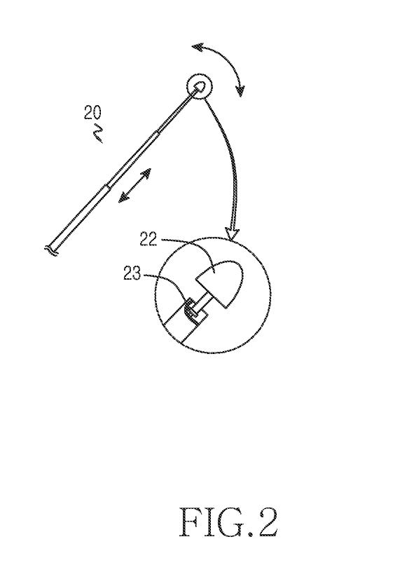

FIG. 2 depicts a construction of an antenna according to an exemplary embodiment of the present invention.

Referring to FIG. 2, the antenna 20 includes a push switch 23. When a free end 22 of the antenna 20 is pushed, the push switch 23 turns On. The electronic device 20 performs a user interface operation resulting from the turning On or Off of the push switch 23 of the antenna 20. The push switch 23 does not necessarily have to be constructed inside the antenna 20, and can have various mechanisms of switching On or Off according to a motion of the antenna 20.

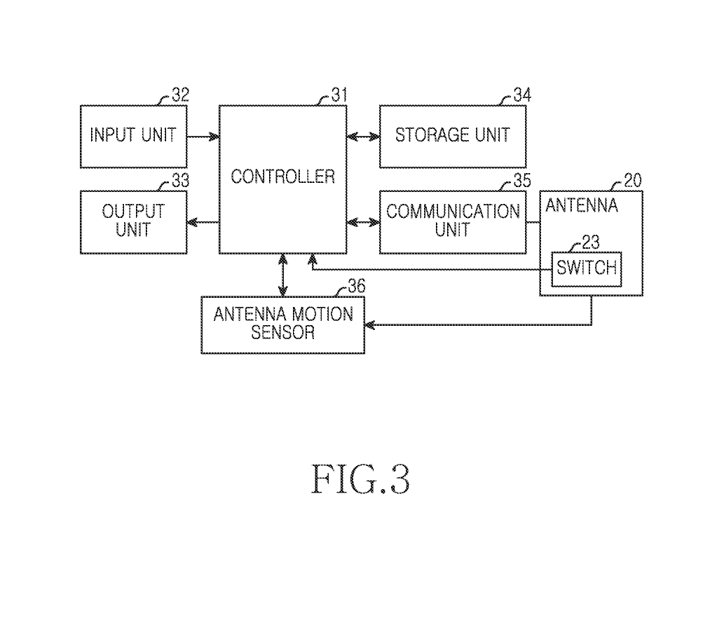

FIG. 3 is a block diagram illustrating a construction of an electronic device according to an exemplary embodiment of the present invention.

Referring to FIG. 3, the electronic device includes a controller 31, an input unit 32, an output unit 33, a storage unit 34, a communication unit 35, an antenna 20, a switch 23, and an antenna motion sensor 36.

The controller 31 controls the setting of an execution environment of the electronic device 20, maintaining its information, allowing stable driving of the electronic device 20, and making smooth data input/output exchange of all units of the electronic device 20. Also, the controller 31 can include a COder and DECoder (CODEC) (not shown) for converting a signal that is associated with a video and voice through the output unit 33.

The input unit 32 outputs to the controller 31 an input signal that is associated with control operation of the controller 31.

The output unit 33 outputs a signal received from the controller 31, for example as a video or voice.

The storage unit 34 stores data about a user interface operation associated with an operation of the electronic device 20. The controller 31 provides the user interface operation according to the present invention, with reference to the data provided from the storage unit 34.

The communication unit 35 processes a signal of a service of a corresponding communication frequency band. The controller 31 can carry out an operation of the communication unit 35 in parallel.

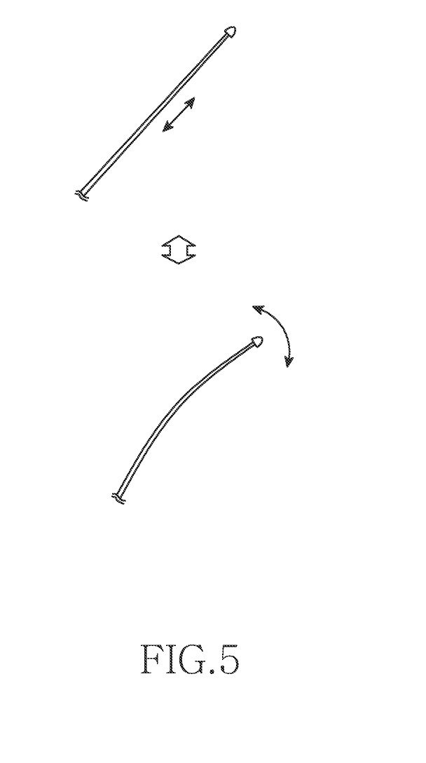

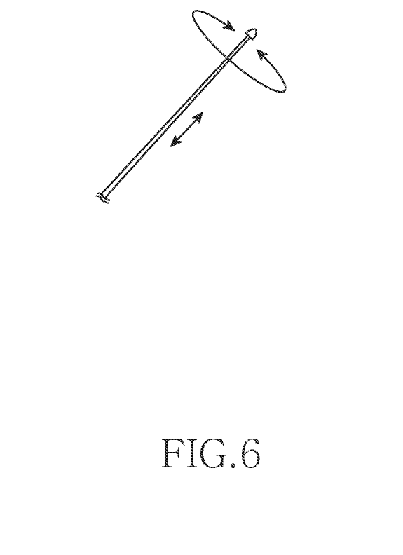

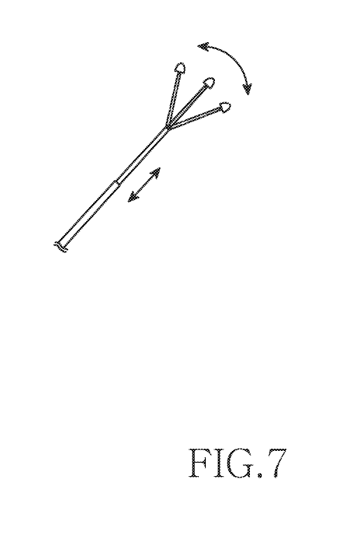

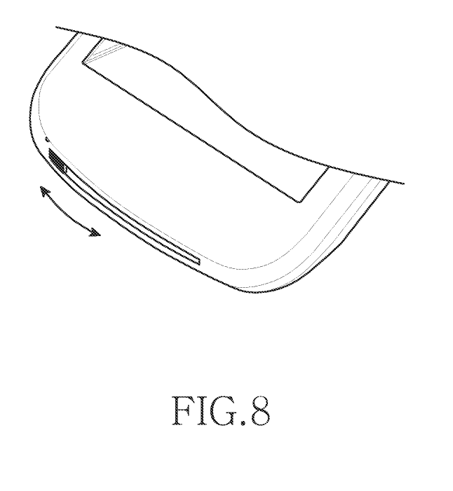

The antenna 20 can permit one or more motions from among rotation, retraction, sliding movement, and bending. FIGS. 5 to 8 depict antennas according to exemplary embodiments of the present invention. The antenna depicted in FIG. 5 is bendable. Also, the antenna depicted in FIG. 6 can rotate on a pivot of a central axis. Also, the antenna depicted in FIG. 7 can rotate only in part. Also, the antenna depicted in FIG. 8 is slidingly movable.

As aforementioned, the antenna 20 can include the push switch 23, and the push switch 23 turns On or Off according to a motion of the antenna 20. The controller 31 outputs a user interface operation resulting from the switching On or Off of the push switch 23, to the output unit 33 with reference to data of the storage unit 34.

The antenna motion sensor 36 senses a motion of the antenna 20, for example, one or more motions from among rotation, retraction, sliding movement, and bending, and outputs information of the sensed motion to the controller 31. The controller 31 outputs a user interface operation dependent on the motion information received from the antenna motion sensor 36, to the output unit 33 with reference to data of the storage unit 34. The controller 31 may execute a role of the antenna motion sensor 36 in parallel.

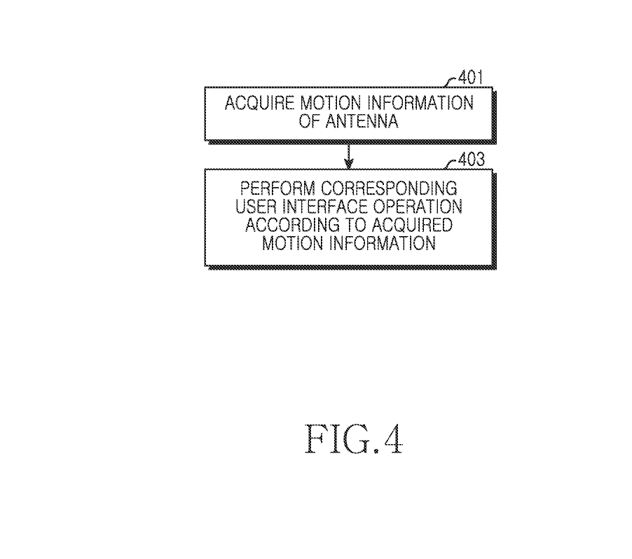

FIG. 4 is a flowchart illustrating a procedure of performing a user interface operation according to an exemplary embodiment of the present invention.

Referring to FIG. 4, in step 401, the controller 31 acquires motion information of an antenna. As aforementioned, the motion information of the antenna refers to information about one or more motions from among rotation, retraction, sliding movement, and bending.

Next, in step 403, the controller 31 performs a corresponding user interface operation according to the acquired motion information. For instance, when moving an object, the controller 31 can determine a movement direction from the motion information. Also, when performing volume adjustment, the controller 31 can determine a volume level from the motion information. That is, the motion information can be an index of determining a physical amount, i.e., a scalar amount.

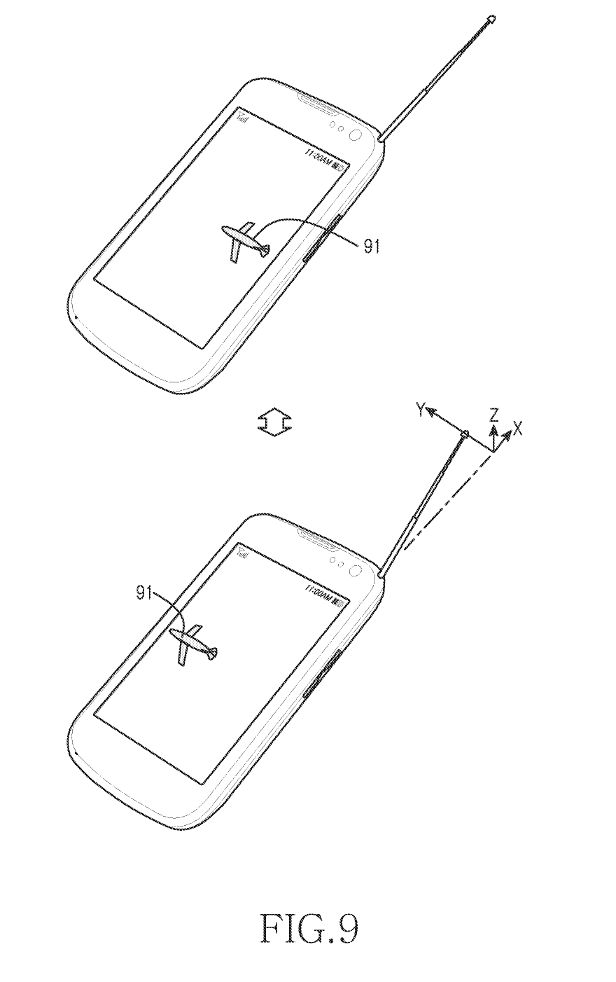

The controller 31 can move an object of a screen of the output unit 33, correspondingly to the motion information. FIG. 9 depicts a user interface screen according to an exemplary embodiment of the present invention. Referring to FIG. 9, when a user moves an antenna, an object 91 of the screen is moved. A movement direction, distance, and speed of the object 91 can be determined according to the movement of the antenna.

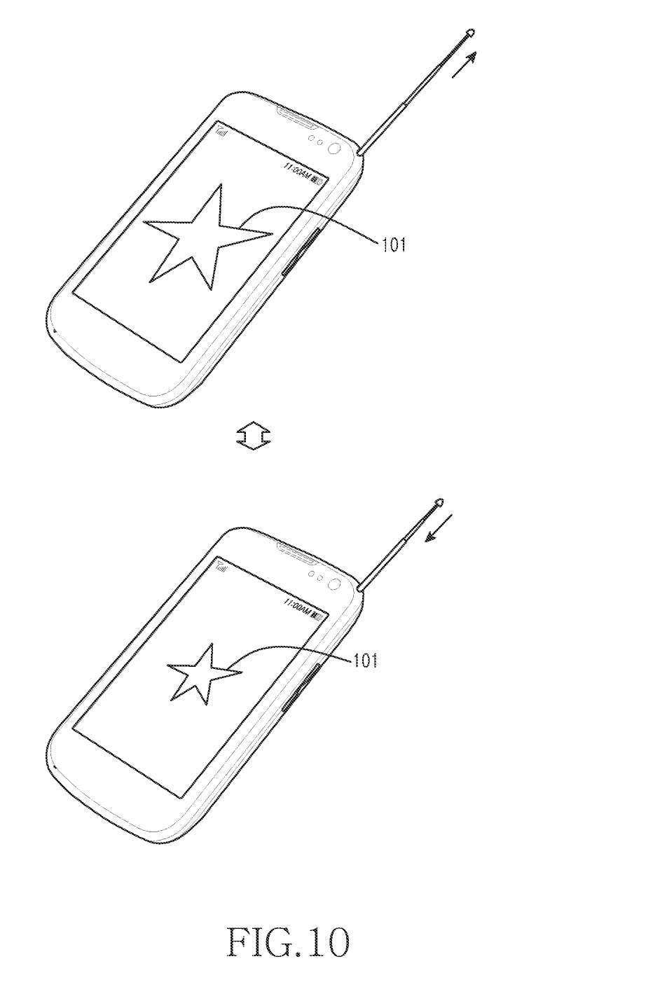

The controller 31 can zoom in or out on content of a screen through the output unit 33, in accordance with the motion information. FIG. 10 depicts a user interface screen according to an exemplary embodiment of the present invention. In the top part of FIG. 10 a device is shown with an extended antenna. In the bottom part of FIG. 10, the same device is shown with the antenna retracted. Referring to FIG. 10, when a user retracts an antenna, content 101 of the screen is zoomed in or out and displayed. A rate of zoom-in or zoom-out can be proportional to a retraction level of the antenna.

The controller 31 may convert content of the screen through the output unit 33, into previous content or next content according to the motion information. For example, if an antenna is tilted forward, the controller 31 can turn an electronic book to a next page and, if the antenna is tilted backward, the controller 31 can turn the electronic book to a previous page. A speed of page turning can be proportional to a tilt angle of the antenna.

The controller 31 may adjust an output volume through the output unit 33, according to the motion information. For example, the controller 31 can adjust an output volume according to a rotation direction of the antenna illustrated in FIG. 6.

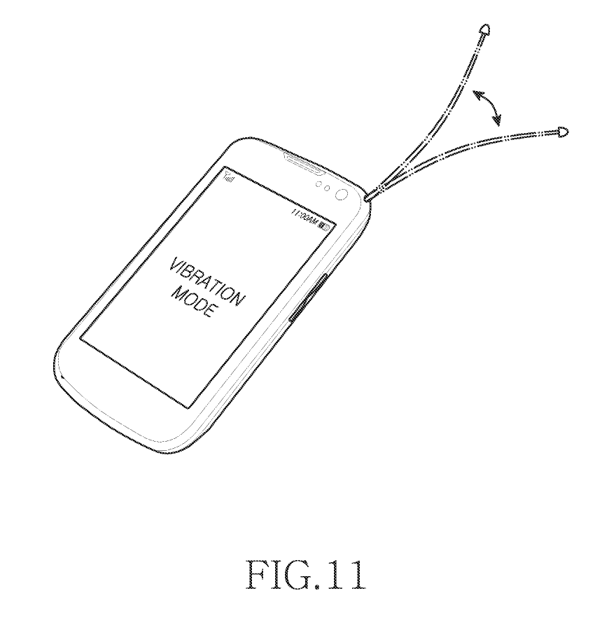

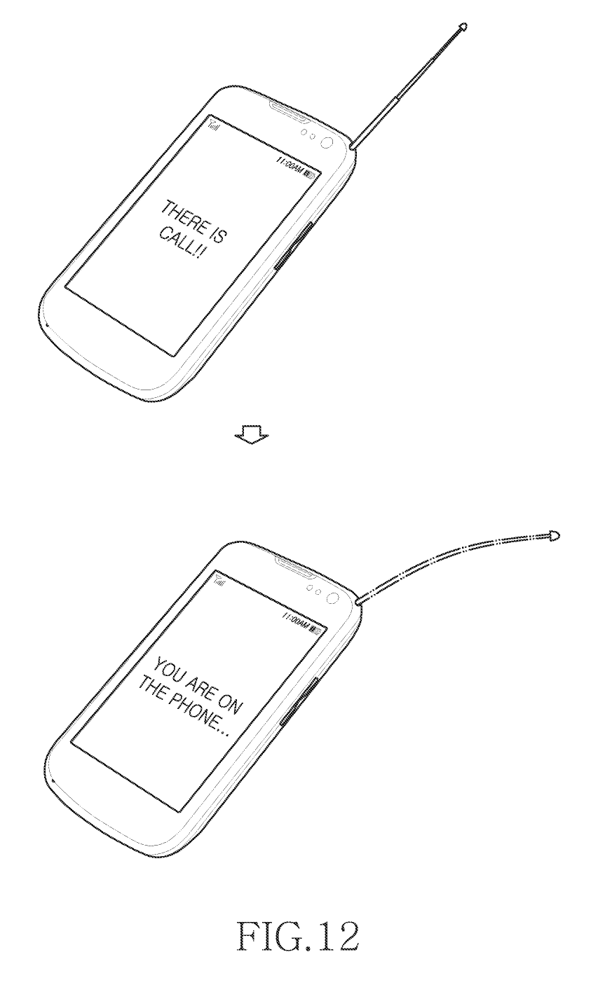

If a specific motion of the antenna is sensed, the controller 31 may automatically perform a corresponding function. That is, the controller 31 can trigger-operate using the antenna. FIGS. 11 and 12 depict user interface screens according to exemplary embodiments of the present invention. Referring to FIG. 11, if a user releases after bending an antenna, the antenna can be vibrated, and the electronic device can correspondingly change a call-incoming alarm mode into a vibration mode. Referring to FIG. 12, when there is an incoming call from a caller, the electronic device can accept the call if a user bends an antenna.

Besides this, the present invention can include various user interface operations using motion information of an antenna. As a result, the present invention can satisfy a feeling of user's manipulation in a GUI environment based on 3D graphics. Further, because the present invention uses an antenna essential to an electronic device performing wireless communication without adding a separate hardware manipulation means, it makes a contribution to the miniaturization of the electronic device.

As described above, an exemplary electronic device according to the present invention can have an effect, because of performing a user interface operation using an antenna, of enhancing a user's convenience and feeling of satisfactory manipulation.

Methods according to exemplary embodiments disclosed in the claims and/or the specification of the present invention can be implemented in a form of hardware, software, or a combination of hardware and software.

In the case of implementing in software, a nonvolatile computer readable storage medium storing one or more programs (i.e., software modules) is provided. The one or more programs stored in the computer readable storage medium are configured to be executable by one or more processors within an electronic device. The one or more programs include instructions for enabling the electronic device to execute the methods according to the exemplary embodiments disclosed in the claims and/or the specification of the present invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An electronic device comprising:
an output unit for outputting a video or voice;
a storage unit for storing information about a user interface operation;
an antenna for transmitting/receiving a wireless signal of a corresponding communication frequency band, wherein the antenna is moveable;
a sensor for acquiring information of at least one motion of the antenna; and
a controller for processing a wireless signal through the antenna and for outputting the user interface operation according to the information received from the sensor, to the output unit with reference to the information of the storage unit.

2. The electronic device of claim 1, wherein the at least one motion of the antenna comprises one of rotation, retraction, extension, sliding movement, and bending.

3. The electronic device of claim 1, wherein the controller determines a movement distance of an object on a screen, a movement direction of the object, or a movement speed of the object according to the information of the at least one motion of the antenna.

4. The electronic device of claim 1, wherein the controller determines a physical amount, which is associated with a corresponding operation, according to the information of the at least one motion of the antenna.

5. The electronic device of claim 1, wherein the user interface operation comprises the controller controlling to move an object of a screen through the output unit, according to the information of the at least one motion of the antenna, or
to convert content of the screen through the output unit into previous content or next content according to the information of the at least one motion of the antenna, or
to zoom in or out the content of the screen through the output unit according to the information of the at least one motion of the antenna, or
to adjust a volume through the output unit according to the information of the at least one motion of the antenna.

6. The electronic device of claim 5, wherein the movement of the object, the conversion of the content, the zooming of the content, and the adjustment of the volume are each proportional to the corresponding at least one motion of the antenna.

7. The electronic device of claim 1, wherein the antenna includes one or more constructions from among a construction capable of rotating one end on a pivot of another end, a construction capable of turning on a pivot of a central axis, a retractable construction, an extensible construction, a bendable construction, and a sliding movable construction.

8. The electronic device of claim 1, wherein the antenna can be retracted inside the electronic device and extended outside the electronic device.

9. The electronic device of claim 1, wherein the communication frequency band comprises one of a band for telephone calls and a band for Digital Multimedia Broadcasting (DMB).

10. The electronic device of claim 1, further comprising a switch for outputting an On signal or an Off signal to the controller according to a motion of the antenna,
wherein the controller loads a corresponding user interface operation from the storage unit according to the On signal or Off signal received from the switch, and outputs the user interface operation to the output unit.

11. A method for a user interface comprising:
acquiring information of at least one motion of an antenna; and
performing a user interface operation according to the information of the at least one motion of the antenna.

12. The method of claim 11, further comprising determining the user interface operation according to the acquired information of the at least one motion of the antenna, with reference to previously stored information.

13. The method of claim 11, wherein the at least one motion of the antenna comprises one of rotation, retraction, extension, sliding movement, and bending.

14. The method of claim 11, wherein the user interface operation determines a movement distance of an object of a screen, a movement direction of the object, or a movement speed of the object according to the information of the at least one motion of the antenna.

15. The method of claim 11, wherein the user interface operation determines a physical amount, which is associated with a corresponding operation, according to the information of the at least one motion of the antenna.

16. The method of claim 11, wherein the user interface operation moves an object of a screen according to the information of the at least one motion of the antenna, or
converts content of the screen into previous content or next content according to the information of the at least one motion of the antenna, or
zooms in or out the content of the screen according to the information of the at least one motion of the antenna, or
adjusts a volume according to the information of the at least one motion of the antenna.

17. The method of claim 16, wherein the movement of the object, the conversion of the content, the zooming of the content, and the adjustment of the volume are each proportional to the corresponding at least one motion of the antenna.

18. The method of claim 11, wherein the antenna includes one or more constructions from among a motion construction capable of rotating one end on a pivot of another end, a motion construction capable of turning on a pivot of a central axis, a retractable construction, an extensible construction, a bendable construction, and a sliding movable construction.

19. The method of claim 11, wherein the antenna can be retracted inside the electronic device and extended outside the electronic device.

20. The method of claim 11, wherein the communication frequency band comprises one of a band for telephone calls and a band for Digital Multimedia Broadcasting (DMB).

21. The method of claim 11, further comprising sensing an On signal or an Off signal of a switch resulting from a motion of the antenna, and performing a user interface operation according to the On signal or Off signal.

22. An electronic device comprising:
means for outputting a video or voice;
means for storing information about a user interface operation;
an antenna for transmitting/receiving a wireless signal of a corresponding communication frequency band, wherein the antenna is moveable;
means for acquiring information of at least one motion of the antenna; and
means for processing a wireless signal through the antenna and outputting the user interface operation according to the information of the at least one motion of the antenna with reference to the information of the storage means.
